(19) United States
(12) Patent Application Publication
(10) Pub. No.: US 2018/0313106 A1
(43) Pub. Date: Nov. 1, 2018

(54) INTERNAL COLUMN AND PLATFORM STRUCTURES IN A TOWER

(71) Applicant: Wind Tower Technologies, LLC, Boulder, CO (US)

(72) Inventor: Matthew J. Chase, Windsor, CO (US)

(73) Assignee: Wind Tower Technologies, LLC, Boulder, CO (US)

(21) Appl. No.: 15/654,555

(22) Filed: Jul. 19, 2017

Related U.S. Application Data
(60) Provisional application No. 62/490,358, filed on Apr. 26, 2017.
(60) Provisional application No. 62/532,189, filed on Jul. 13, 2017.

(51) Int. Cl. E04H 12/10; E04H 12/08; E06C 9/02

(52) U.S. Cl. CPC E04H 12/10; E04H 2012/006; E06C 9/02; E04H 12/085

(57) ABSTRACT

A tower can include a plurality of annular tower sections connected to and aligned with one another, an internal support structure spanning at least a length of the tower, and a ladder incorporated into the internal support structure.

### RELATED APPLICATIONS

This application claims priority to U.S. Patent Application Ser. No. 62/490,358 filed on 26 Apr. 2017 and titled Tower Internals. This application also claims priority to U.S. Patent Application Ser. No. 62/532,189 filed on 13 Jul. 2017 and titled Tower Internals. Each of these references is herein incorporated by reference for all that they contain.

### BACKGROUND

Steel wind towers are commonly built through bolting steel tubular sections together at intermediate flanges. The size of the steel tower sections allows them to be physically transported from the fabrication location to the wind farm site without significant modifications to existing roads, bridges, or other physical constraints.

Steel wind towers are often fitted with an internal ladder system. One type of ladder system for a tower is disclosed in U.S. Pat. No. 6,782,667 issued to Allan P. Henderson. In this reference, a ladder structure is mounted internal to a tower, the ladder including three segments, each corresponding to the length of the respective tower section in which it will be mounted. The uppermost ladder section disposed in the uppermost tower section is assembled and rigidly installed in the fabrication shop on the interior of the wall of the tower section by vertically spaced brackets rigidly attached to the inner surface of the tower section and supporting the uppermost ladder section. The uppermost ladder section is directed inwardly from the interior surface of the tower section. The ladder sections for a first tower section and a second tower section include temporary mounting of ladder supporting brackets that are folded downward and against the ladder sections and held in folded position by tape or tie straps to permit the two sections to be nested within the installed ladder section in their respective tower section. After the tower sections are nested at the job site and before the tower is tilted vertically, the bottoms of each nested ladder section are affixed to horizontal pivot members at the bottom of each tower section. As the tower sections are extended vertically, the nested ladder sections are automatically withdrawn from their nested position and extend in longitudinal relation to each tower section. This reference is herein incorporated by reference for all that it contains.

### SUMMARY

In one embodiment, a tower includes a plurality of annular tower sections connected to and aligned with one another, an internal support structure spanning at least a length of the tower, and a ladder incorporated into the internal support structure.

The tower can further include a tower foundation, and the internal support structure can be directly connected to the tower foundation.

The tower can include a first annular tower section of the plurality of annular tower sections, a second annular tower section aligned with the first annular tower section, a first annular connection flange connected to the first annular tower section, a second annular connection flange connected to the second annular tower section, and a bracket connecting at least one of the first annular tower section or the second annular connection flange to the internal support structure. The first annular connection flange and the second annular connection flange can be bolted together.

The tower can include a tower foundation and a foundation connection where the internal support structure is directly connected to the tower foundation. The bracket can be a shipping bracket. A weight of a segment of the internal support structure can be loaded into the bracket when the annular tower section is oriented in a shipping position. The weight of the segment of the internal support structure can be loaded into the tower foundation at the foundation connection between the internal support structure and the tower foundation when the first annular tower section is oriented in an erected position.

The tower can include a first end of the first annular tower section, a second end of the first annular tower section opposite of the first end, a third annular connection flange located at a second end of the first annular tower section, and an inner surface of the first annular tower section spaced apart between the first annular connection flange and the third annular connection flange. The inner surface can be substantially free of connections to the ladder.

The internal support structure can include a triangular cross section.

The internal support structure can be a truss.

The internal support structure can define an internal cavity that is aligned with a length of the internal support structure and at least one suspension cable is disposed within the cavity.

The tower can include an opening defined in the internal support structure that connects an outside of the internal support structure to the cavity and the ladder is disposed within the opening.

The tower can include a platform located within the tower and connected to the internal support structure.

The tower can include at least one connection flange located at an end of an annular tower segment and at least one suspension cable connected to the connection flange. The platform can be suspended by the suspension cable from the connection flange.

The platform can include a floor. The floor can include a first floor segment made of a sheet metal material, a first folded portion of the first floor segment, a second floor segment made of the sheet metal material, and a second folded portion of the second floor segment. The first folded section and the second folded section can be connected through a non-welded attachment.

The sheet metal material can be a pre-galvanized aluminum material.

The tower can include a first end of an annular tower segment, an annular connection flange connected to the first end, and an annular bolt holster connected to the annular connection flange.

The tower can include a pivot joint, a pivot structure connected to the internal support structure at the pivot joint, a first cable loop opening incorporated into a first side of the pivot structure, and a second cable loop opening incorporated into a second side of the pivot structure.

The pivot structure can pivot in response to a twisting of a cable when a portion of the cable is secure to the first cable loop opening and the second cable loop opening.

In one embodiment, an annular tower section includes a segment of an internal support structure spanning at least a length of the annular tower section, a ladder incorporated into the segment of the internal support structure, a first end of the first annular tower section, a second end of the first annular tower section opposite the first end, a first annular connection flange connected to the first end, a second annular connection flange connected to the second end, a bracket connecting the annular tower section to the internal support structure, and an inner surface of the first annular tower section spaced apart between the first annular connection flange and the second annular connection flange. The inner surface can be substantially free of connections to the ladder.

The annular tower section can be incorporated into a tower. The weight of the segment of the internal support structure can be loaded into a tower foundation at a connection between the internal support structure and the tower foundation and the inner surface can be substantially free of connections to the internal support structure.

The annular tower section can include an annular bolt holster connected to at least one of the first the annular connection flange or the second annular connection flange.

The annular tower section can include a pivot joint, a pivot structure connected to the internal support structure at the pivot joint, a first cable loop opening incorporated into a first side of the pivot structure, and a second cable loop opening incorporated into a second side of the pivot structure.

### BRIEF DESCRIPTION OF THE DRAWINGS

FIG. 1 depicts an example of a tower with an internal support structure in accordance with aspects of the present disclosure.

FIG. 2 depicts an example of an internal support structure in accordance with aspects of the present disclosure.

FIG. 3 depicts an example of a cross section of an internal support structure in accordance with aspects of the present disclosure.

FIG. 4 depicts an example of a platform and an internal support structure in accordance with aspects of the present disclosure.

FIG. 5 depicts an example of a top view of a platform in accordance with aspects of the present disclosure.

FIG. 6 depicts an example of a floor segment in accordance with aspects of the present disclosure.

FIG. 7 depicts an example of a suspension cable attached to a platform in accordance with aspects of the present disclosure.

FIG. 8 depicts an example of a side of a platform in accordance with aspects of the present disclosure.

FIG. 9 depicts an example of an internal support structure connected to a tower foundation accordance with aspects of the present disclosure.

FIG. 10 depicts an example of a platform connected to an internal support structure and cabling in accordance with aspects of the present disclosure.

FIG. 11 depicts an example of a holster connected to a connection flange in accordance with aspects of the present disclosure.

FIG. 12 depicts an example of a pivot structure connected to an internal support structure in accordance with aspects of the present disclosure.

FIG. 13 depicts an example of cabling secured within a pivot structure in accordance with aspects of the present disclosure.

FIG. 14 depicts an example of cabling secured within a pivot structure in accordance with aspects of the present disclosure.

FIG. 15 depicts an example of cabling secured within a pivot structure in accordance with aspects of the present disclosure.

### DETAILED DESCRIPTION

For purposes of this disclosure, the term “aligned” means parallel, substantially parallel, or forming an angle of less than 35.0 degrees. For purposes of this disclosure, the term “transverse” means perpendicular, substantially perpendicular, or forming an angle between 55.0 and 125.0 degrees. Also, for purposes of this disclosure, the term “length” means the longest dimension of an object. Also, for purposes of this disclosure, the term “width” means the dimension of an object from side to side. Often, the width of an object is transverse the object's length.

Towers are used to support many structures, such as windmills and utility lines. In conventional towers for windmills, platforms and ladders are connected directly to the inside surface of the tower wall. These connection points can weaken the strength of the tower, especially due to fatigue, which can be caused by varying levels of wind or other lateral loads imposed on the towers.

The principles described in this disclosure include internal tower components that are supported by annular connection flanges, which are located at the ends of the annular tower sections and/or the tower's foundation. Thus, the inner surface of the tower/annular tower sections can be substantially free of load bearing connections. In some cases, the inner surface of the tower is substantially free of all connections to internal components.

To facilitate the erection and transportation of the tower, the tower's internal components, such as platforms and internal support members can be secured to the annular connection flanges when the annular tower sections are oriented in a shipping position. For example, the annular tower section can be oriented in a horizontal position for transportation in a truck to a tower's construction site. In other examples, the internal tower components are installed at the construction site when the annular tower section is in a horizontal position. In the horizontal position, brackets that are connected to the annular connection flanges can space the internal components, such as the internal support structure, off of the inner surface without making a connection to the inner surface. In this horizontal position, theses brackets are load bearing. When the tower is erected, the weight of the internal support structure is transferred down the length of the internal support structure into the tower's foundation. In this orientation, the brackets are no longer load bearing. However, the brackets can be left in place to reduce the construction time. In this example, even though the brackets connect the internal support structure to the annular connection flanges, the brackets are not load bearing. However, in some examples, the brackets can be removed about the erection of the tower.

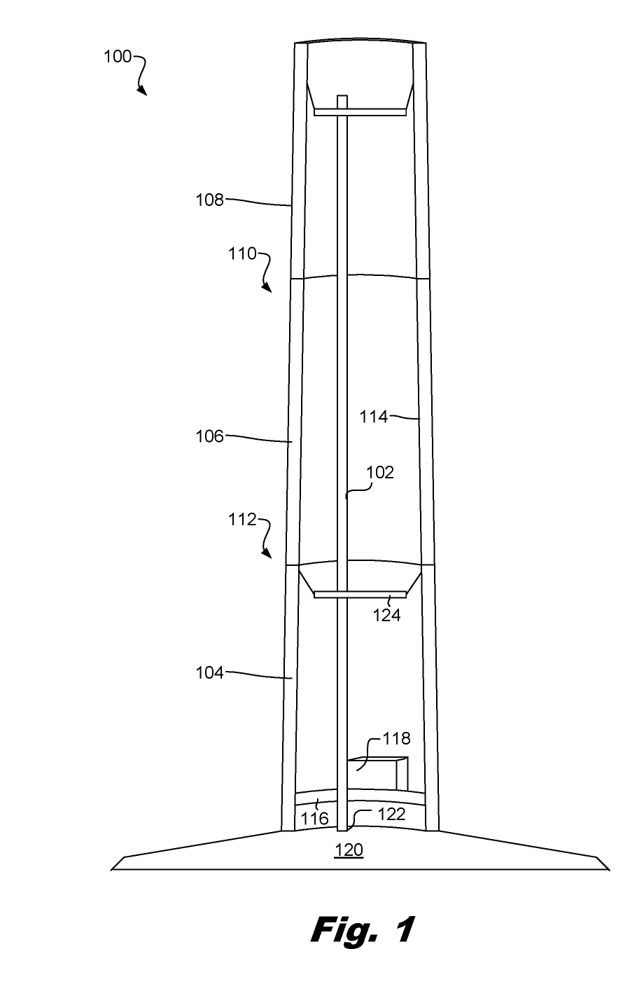

FIG. 1 depicts an example of a tower 100 with an internal support structure 102 in accordance with aspects of the present disclosure. In this example, the tower 100 includes a first annular tower section 104, a second annular tower section 106, and a third annular tower section 108. Each annular tower section is aligned with the other annular tower sections and connected from end to end to create a stack of annular tower sections to form the tower 100. Each annular tower section includes a first end 110 and a second end 112. A connecting flange can be connected to the first end, the second end, or combinations thereof. In this example, each of the annular tower sections are oriented in an erected position. While this example is depicted with three annular tower sections 104, 106, 108, any appropriate number of annular tower sections can be used to construct the tower.

The annular tower sections can collectively define an interior of the tower 100 that is defined by an inner surface 114 of the annular tower sections. This interior can house multiple internal tower components. In this example, the internal tower components include multiple platforms 124 that are suspended from the annular connection flanges. The internal components can also include an internal support structure 102 that spans at least a portion of the length of the tower 100. A tower floor 116 can be incorporated into the internal space of the tower 100. Equipment, such as a power unit 118, can rest on the tower floor 116. In some examples, the power unit 118 or other types of equipment can occupy the center location in the tower 100. In those examples, the internal support structure 102 can be offset from the center to make room for the equipment. The internal support structure 102 can be supported by a tower foundation 120 located underneath the floor. In some cases, the tower's floor is the top surface of the tower foundation 120, but in other examples, the tower floor 116 is raised above the surface of the tower foundation 120.

The tower foundation 120 can transfer the weight of the tower 100 to the earth. The tower foundation 120 can be made by digging into the earth to a sufficient depth. In some cases, a sufficient depth is deep enough to reach a subsoil, which is more solid than the topsoil. In other cases, the depth is sufficient without passing into another type of soil. In some cases, a steel rebar frame is constructed in the hole, and concrete is poured into the hole over the rebar frame. When the concrete cures, the steel resists tensile loads on the concrete slab, and the concrete resists the compressive loads on the concrete slabs. The concrete slab can include a tapered shape, and the tapered portion of the slab can be covered with soil after these portions have cured. The tower 100 can be erected on a central, flat portion of the concrete slab that remains uncovered with soil. In some examples, the internal support structure 102 is directly connected to the tower foundation 120 at a foundation connection 122.

The annular tower sections can be made of any appropriate type of material. In some examples, the tower sections are made of steel. Any appropriate type of steel can be used. A non-exhaustive list of types of steel that can be used include stainless steel, alloys steel, carbon steel, other types of steel, or combinations thereof. In other examples, the annular tower sections are made of concrete.

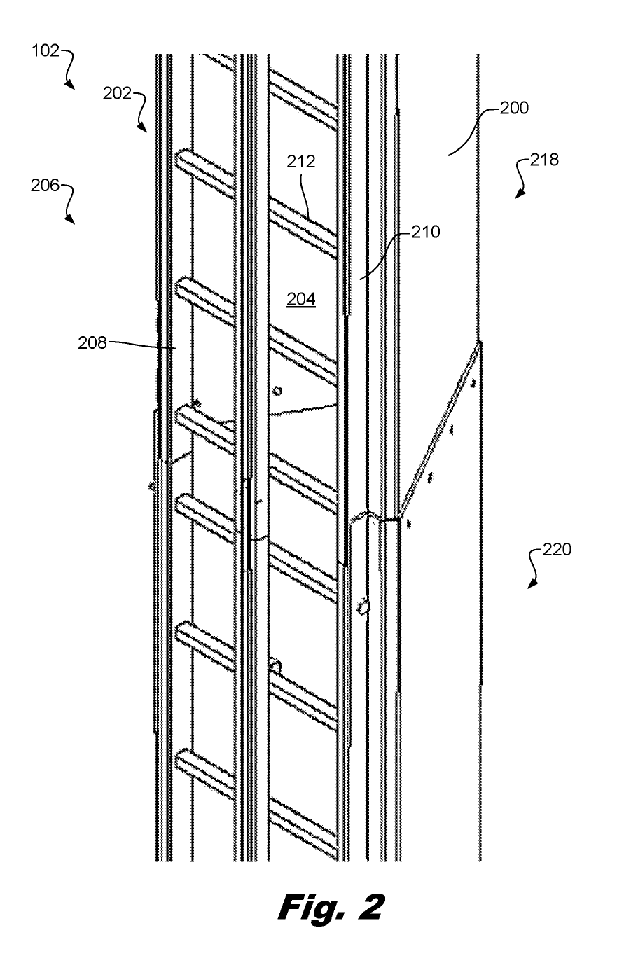

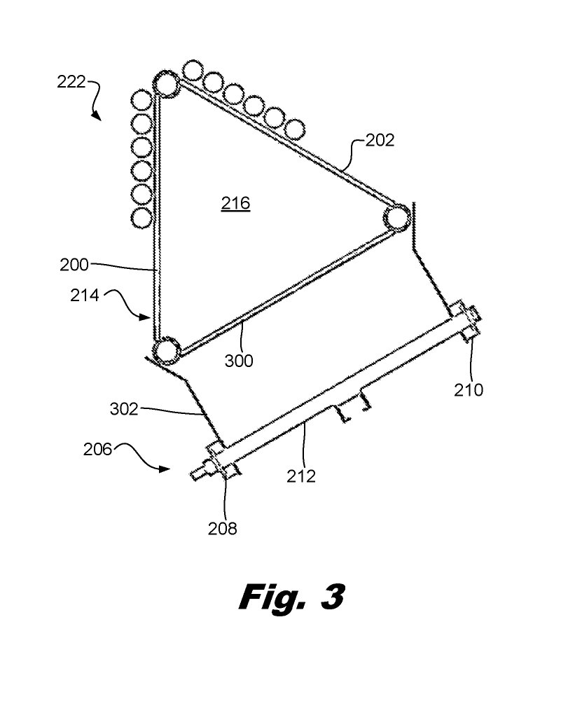

FIGS. 2 and 3 depict an example of an internal support structure 102 in accordance with aspects of the present disclosure. FIG. 2 depicts an embodiment without cabling 222 attached to the internal support structure 102. FIG. 3 depicts an embodiment with cabling 222 attached to the outside 214 of the internal support structure 102.

In these examples, the internal support structure 102 has a triangular shape. The triangular shape includes a first structure wall 200 connected to the second structure wall 202 that are joined at an angle between 45 degrees and 120 degrees. The third side of the internal support structure 102 defines an opening 204, and a ladder 206 is disposed within the opening 204. The ladder 206 includes a first rail 208 connected to one side of the internal support structure 102 and a second rail 210 connected to the other side of the internal support structure 102. The first rail 208 and the second rail 210 are connected by a plurality of ladder rungs 212. The opening 204 may connect the outside 214 of the internal support structure 102 to an internal cavity 216 of the internal support structure 102. The internal cavity 216 can be defined by the first structure wall 200, the second structure wall 202, and the third side of the internal support structure 102. The internal cavity 216 can include a length that is aligned with the length of the internal support structure 102.

Any appropriate type of ladder can be associated with the internal support structure 102. For example, the internal support structure 102 can include a ladder that is fastened to a solid wall defining, in part, a portion of the internal support structure's internal cavity 216. In other examples, the internal support structure 102 can be a truss, and beams of the truss can be situated to be ladder rungs 212. In yet other examples, the ladder can include a single, central rail, and the ladder rungs 212 are attached to that central rail.

The internal support structure 102 can be made of multiple segments. In some examples, each annular tower section has an internal support structure segment installed prior to incorporating the annular tower section into the tower 100. As the annular tower sections come together, their corresponding internal support structure segments can also align so that they can be connected to one another to form a continuous internal support structure 102. In the example of FIG. 2, a first internal support structure segment 218 is connected to a second internal support structure segment 220. Each of the segments can be bolted together, welded together, or otherwise fastened together. The weight of the higher of the two segments is loaded onto the weight of the lower internal support structure segment.

This space within the cavity of the internal support structure 102 can include any appropriate type of equipment and/or device. In some examples, cables are disposed within the internal support structure 102. In other examples, such as the example in FIG. 3, the cables are located on the outside 214 of the internal support structure 102. In those examples where the cables reside on the outside 214 of the internal support structure 102, the cables can be attached to the outside 214 of the internal support structure 102 through clips or another type of connection device. The cabling 222 can be bundled together, and the bundle can be connected to the outside 214 of the internal support structure 102. The cabling 222 can run power and/or data from the power equipment or other types of equipment located in the tower 100 to the equipment located at the top of the tower 100. For example, if the tower is a windmill tower, equipment can be located at the top of the tower to drive the wind turbines, and the power for operating this equipment can be transferred from the power unit 118 located on the floor of the tower with the cables.

In the example of FIG. 3, the third side 300 of the internal support structure 102 is a solid wall. In this example, the ladder 206 is affixed to the internal support structure 102 through a ladder bracket 302.

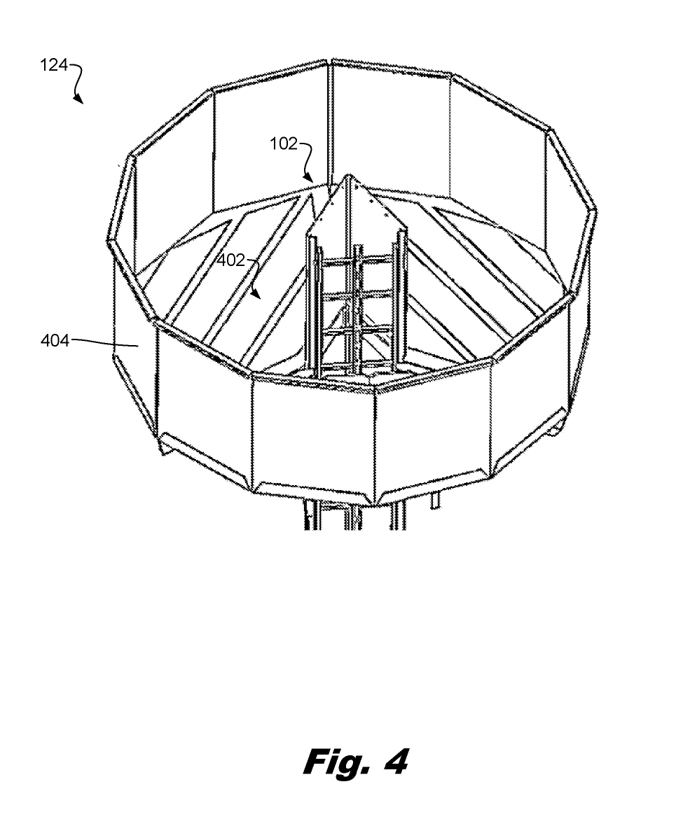

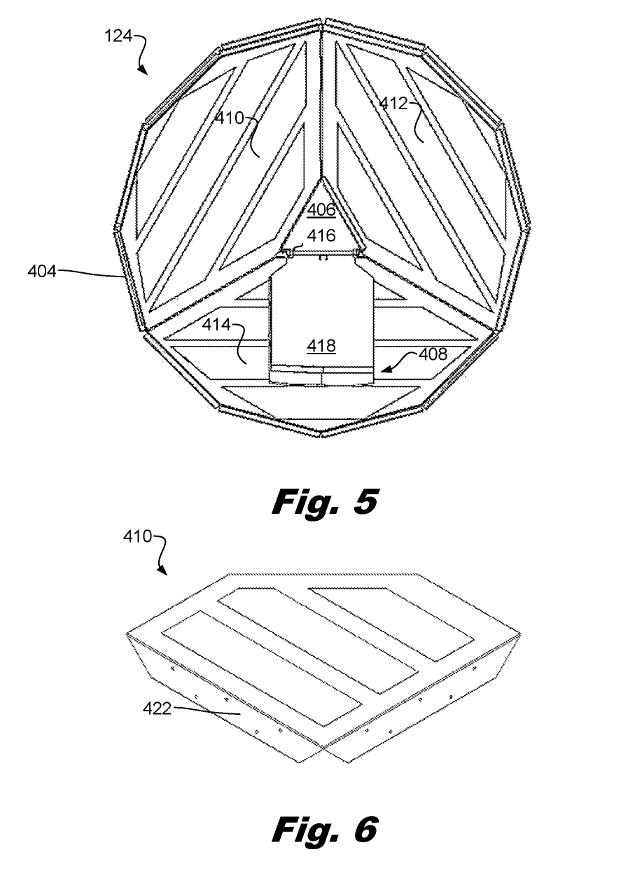

FIGS. 4 and 5 depict an example of a platform 124 and an internal support structure 102 in accordance with aspects of the present disclosure. In this example, the platform 124 is connected to the internal support structure 102. The platform 124 can include a wall. In some examples, the platform 124 also includes a side wall 404. In the example of FIG. 4, the platform 124 encircles a portion of the internal support structure 102. However, in other examples, the platform 124 can be a half size, a quarter size, or another size that is shaped and sized to allow the internal support structure 102 to connect to a side of the platform 124. Various platforms can be spaced along the length of the inside of the tower 100. In some cases, a platform 124 is located adjacent the annular connection flanges to allow a worker to secure the annular tower sections together when erecting the tower 100. Additionally, a platform can be located nearby equipment located at a top of the tower 100 to assist in serving and/or installing that equipment.

The internal support structure 102 can be connected to the platform 124 in any appropriate manner. In another example, the platform 124 can include an opening, and the internal support structure 102 can be at least partially disposed within that opening. The internal support structure 102 can be connected to the platform 124 through that opening. In yet another example, the internal support structure 102 can be connected to the underside of the platform 124. In some examples, the ladder 206 in the internal support structure 102 can provide access to the platform 124 for workers inside the tower 100. The segment of the internal support structure 102 can terminate at the bottom of the platform 124. In some of these cases, another segment of the internal support structure 102 can reside on the top side of the floor 402 of the platform 124, so that the ladder 206 can continue upwards into the tower 100. The first and second segments of the internal support structure 102 can be connected together at the platform 124.

In some examples, a second opening 408 is defined in the floor 402 of the platform 124, which is large enough for a worker to gain access to the platform 124 from the ladder 206. In some cases, a hatch cover 418 is built into the floor 402 of the platform 124 to cover the second opening 408 when the worker is on the platform 124. In some cases, a single opening is large enough to accommodate the passage of the internal support structure 102 and of a worker.

The example of FIG. 5 depicts the second opening 408 for passage of a worker and also the first opening 406 for the internal support structure 102. The first opening 406 includes a triangular shape that accommodates the shape of the internal support structure 102. In other examples where the internal support structure 102 has a different shape than a triangle, the first opening 406 can take the shape of the internal support structure 102.

Any appropriate type of platform can be used in accordance with the principles of the present disclosure. In the example depicted in FIG. 5, the floor 402 is made of multiple floor segments. In some cases, each of the floor segments can be made of sheet metal. The sheet metal can be purchased in rolls, and the floor segments can be cut from the sheet metal.

In this example, the floor 402 includes a first floor segment 410, a second floor segment 412, and a third floor segment 414. In this example, the first opening 406 is collectively defined by a side of each of the first floor segment 410, the second floor segment 412, and the third floor segment 414. The second opening 408 is defined in the third floor segment 414. Further, a hinge 416 is incorporated into the third floor segment 414 adjacent to the first opening 406. The hinge 416 can be connected to the hatch cover 418.

Each of the floor segments can be connected to each other through a non-weld attachment. An example of a non-weld attached can include bolting the floor segments together. In the example of FIG. 6, a floor segment is depicted with a first folded portion 422 bent to be transverse to the floor 402. When situated in the floor, the first folded section can be positioned adjacent to a second fold portion of the adjacent floor segments. The first folded portion 422 and the second folded portion can be bolted together or otherwise attached together. By joining folded sections of the sheet metal together, the floor segments do not need to be welded together. In some cases, welded joints compromise the integrity of a joint and thus needs a stronger and/or thicker floor material. By avoiding the welding actions involved in making a weld joint, the platform floor 402 can be constructed out of a relatively thin material, such as sheet metal.

Another advantage of avoiding a weld joint is that in those examples where it is desirable to have galvanized material in the platform, the platform's material can be galvanized prior to connecting the floor segments together rather than afterwards.

Any appropriate type of sheet metal can be used in accordance with the principles described in the present disclosure. In some cases, the sheet metal is a pre-galvanized aluminum material. Other suitable types of sheet metal can include hot rolled sheets, cold rolled sheets, aluminum, copper, steel, stainless steel, galvanized metal, galvanized steel, aluminum extruded sheets, other types of sheet metal, or combinations thereof.

In some examples, a gripping mechanism is applied to the floor segments. In those examples where the floor segments are made of sheet metal, the sheet metal can include a smooth surface. In these examples, a gripping surface, such as gripping tape, can be adhered to the floor segments. In some examples, a gripping agent can be sprayed, deposited, formed in, or otherwise attached to the surface of the floor segments.

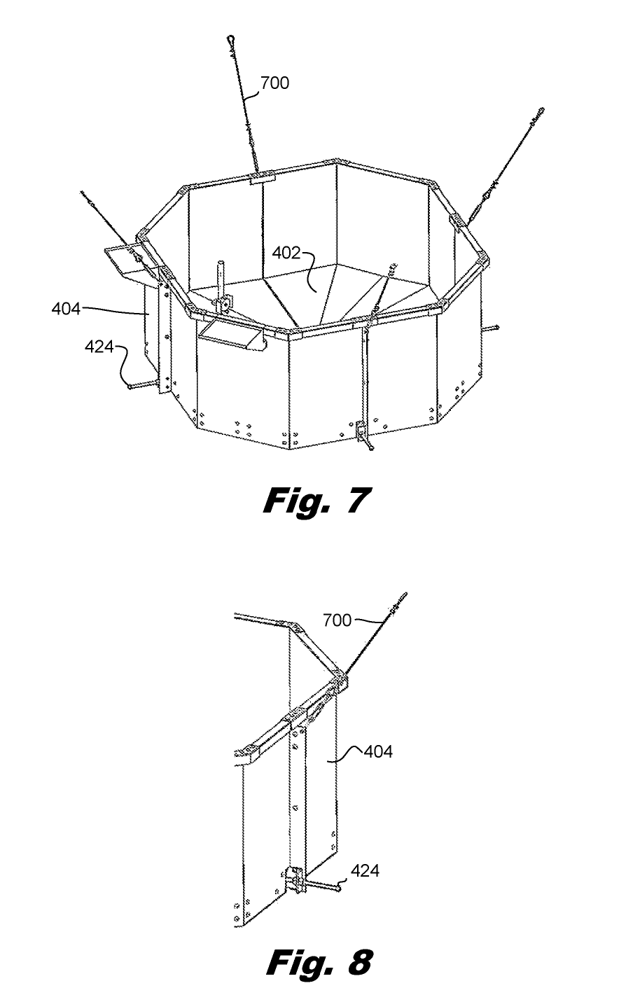

FIGS. 7 and 8 depict an example of a suspension cable 700 attached to a platform in accordance with aspects of the present disclosure. In this example, the platform includes a floor 402 and side walls 404 that are connected to one another. In some cases, the side wall 404 is made of sheet metal, which can be from the same sheet metal roll that is used to make the floor segments.

A suspension cable 401 has a first end that is connected to the platform and a second end that is attached to the annular connection flange. While this example depicts the suspension cables attached to the wall of the platform, the suspension cables can be attached to the platform at any appropriate part of the platform. When the suspension cables are attached, the platform can be suspended within the interior space of the tower 100. In some examples, the suspension cables are secured to the annular connection flanges and to the platform during transportation to the construction site before erection of the tower 100.

By suspending the platform from the annular connection flanges, no load-bearing connections have to be made directly to the inner surface 114 of the annular tower sections. At least one centering rod 424 can protrude from the side and/or from another portion of the platform to space the platform a distance away from the inner surface 114 of the tower 100. In some examples, the centering rods 424 in combination with the suspension cables 700 keep the platform centered in the tower 100. Any contact between the centering rods 424 and the inner surface 114 of the annular tower sections are non-loading bearing when the annular tower sections are in the erected position since they do not transfer the weight of the platform to the inner surface 114. Further, the centering rods 424 are not interconnected with the inner surface 114, thus, a load applied to the centering rods 424 from the platform would cause the centering rod to move with respect to the inner surface 114 of the annular tower sections.

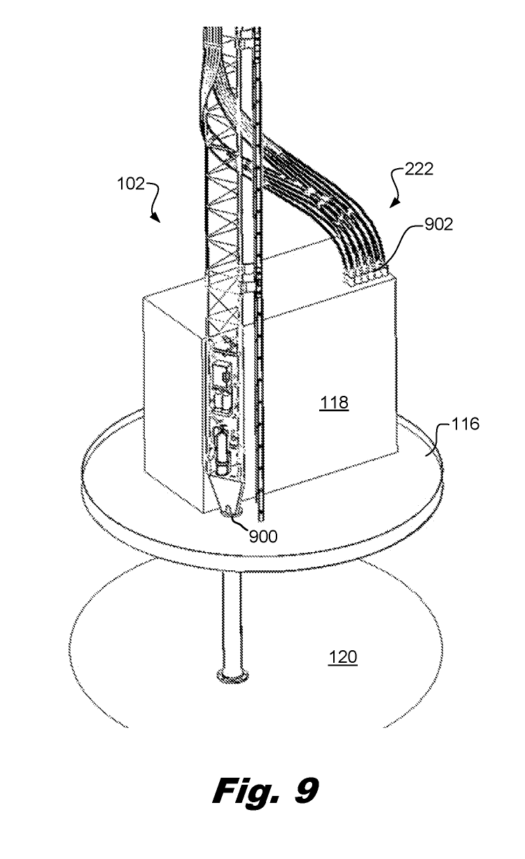

FIG. 9 depicts an example of an internal support structure 102 connected to a tower foundation 120 in accordance with aspects of the present disclosure. In this example, a tower floor 116 is depicted at a height over the tower foundation 120. A power unit 118 rests on the tower floor 116 and cabling 222 supported by the internal support structure 102 are connected to the power unit 118 at a cabling connection 902. A floor opening 900 is defined in the floor 116 through which a portion of the internal support structure 102 passes through into the space beneath the floor 116.

The internal support structure 102 can be connected directly to the tower foundation 120. In some examples, a recess is defined in the tower foundation 120 and a portion of the internal support structure 102 resides in the recess. In some cases, the internal support structure 102 is bolted to the tower foundation 120. In these examples, the bolts can be precast in the tower foundation 120 and these bolts can be used to secure the internal support structure 102 to the tower foundation 120. The weight of the internal support structure 102 can be loaded directly to the tower foundation 120. In some examples, the entire load of the internal support structure 102 is loaded through the length of the internal support structure 102 in the tower foundation 120. In some examples, there are no connections from internal support structure 102 to the inner surface 114 of the annular tower sections. In these examples, the only connections to the internal support structure 102 or other types of internal components along the length of the tower 100 can be to the annular connecting flanges, but not to the inner surface 114 of the annular tower sections.

In some cases, the internal support structure segments are centered within the annular tower sections and are thus centered within the tower 100. In other examples, the internal support structure 102 is off-center with respect to the annular tower sections, and thus off-center in the erected tower 100. In those examples where power units or other types of equipment occupy a central location on the tower floor 116, the internal support structure 102 can be located off-center to accommodate the placement of the power unit 118. In such an example, the entire internal support structure 102 can be off-center.

In alternative examples, a section of the internal support structure 102 can be off-center and another portion of the internal support structure 102 can be centered within the tower 100. In this type of example, the internal support structure 102 can include a section that is transverse to the centered portion and the off-center portion to connect these portions of the internal support structure 102. In yet another example, the off-centered portion of the internal support structure 102 can terminate at a platform and the centered portion can begin at the platform, thus, the platform can serve as a bridge from one portion of the internal support structure 102 to the other. However, in this example, the weight of the centered portion can be transferred to the off-centered portion through the platform or another structure so that the inner surface 114 of the tower wall can be free of connections to the internal support structure 102.

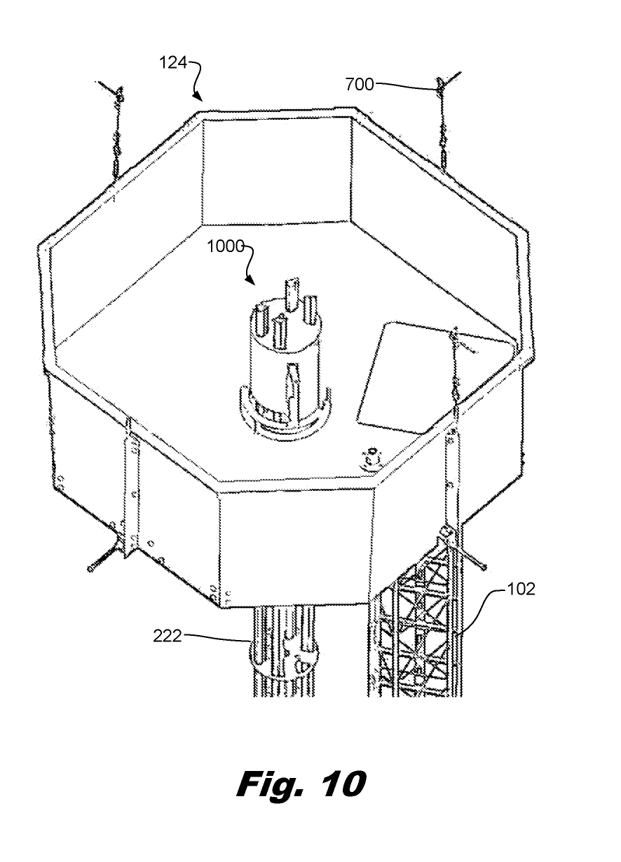

FIG. 10 depicts an example of a platform connected to an internal support structure 102 and cabling 222 in accordance with aspects of the present disclosure. In this example, the depicted platform can be located towards the top of the tower 100. The internal support structure 102 can be connected to the platform and carry cabling 222 from another portion of the tower to this top platform. At the top of the internal support structure 102, cabling terminals 1000 are depicted. The equipment located at the top of the tower 100 can be connected to the cable terminals to provide and/or exchange power and/or data with other equipment in the tower.

In the example of FIG. 10, the cabling 222 is separated from the internal support structure 102, which is offset to provide access to the hatch of the platform. In this example, the cabling 222 is centralized in the platform. In some examples, the cabling 222 is carried by the internal support structure 102 for a significant portion of the length of the tower 100 and is separated from the internal support structure 102 close to the top platform.

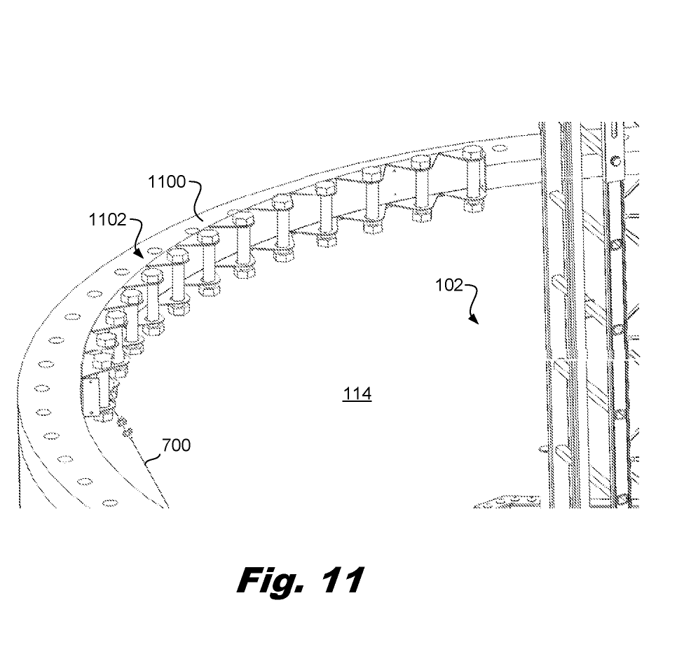

FIG. 11 depicts an example of a holster connected to a connection flange in accordance with aspects of the present disclosure. In this example, a first annular connection flange 1100 is connected at a top end of the annual tower section. The first annular connection flange 1100 can be a piece of steel that is bolted or otherwise connected to the annular tower section. The annular connection flange can be connected to an adjacent annular connection flange of an adjacent annular tower section. These annular connection flanges can be bolted together or otherwise fastened together.

While the annular connection flanges can be used to connect the annular tower sections together, the annular connection flanges can also be used to secure and/or support other components within the tower 100. In the example depicted in FIG. 11, the annular bolt holster 1102 is connected to the annular connection flange. This annular bolt holster 1102 can provide slots into which bolts are secured. The annular bolt holster 1102 can be connected at arms distance from a user standing on the platform and the accessible to the user when the user is connecting the annular connection flanges together.

One advantage of an annular bolt holster 1102 is that when a worker begins the process of bolting the annular tower sections together, the worker can know that all the bolts are accounted for by visibly observing that a bolt is in each of the slots. If a slot is empty, the worker can understand that another bolt is needed to finish the job. The annular bolt holster 1102 also provides the advantage of locating bolts off of the platform, which provides more space for the worker to move around on the platform or for making room for more equipment on the platform. Further, the bolts collectively provide a substantial weight to the platform, but with the bolts located off the platform, the platform does not need to be constructed to carry a higher load to accommodate the weight of the bolts. Thus, the platform can be constructed with lighter materials and/or less expensive materials that can meet the weight requirements that does not include the weight of the bolts.

In some cases, the annular bolt holster has a continuous annular shape that has no end. In other examples, the annular bolt holster is a segment of an annular shape and only connects to a sub-portion of the annular connection flange. The annular bolt holster can be shaped to match a curvature of the annular connection flange.

The suspension cables 700 can also be connected to the annular connection flange. Thus, the weight of the platform can also be loaded to the annular connection flange rather than to a connection made into the inner surface 114 of the tower sections.

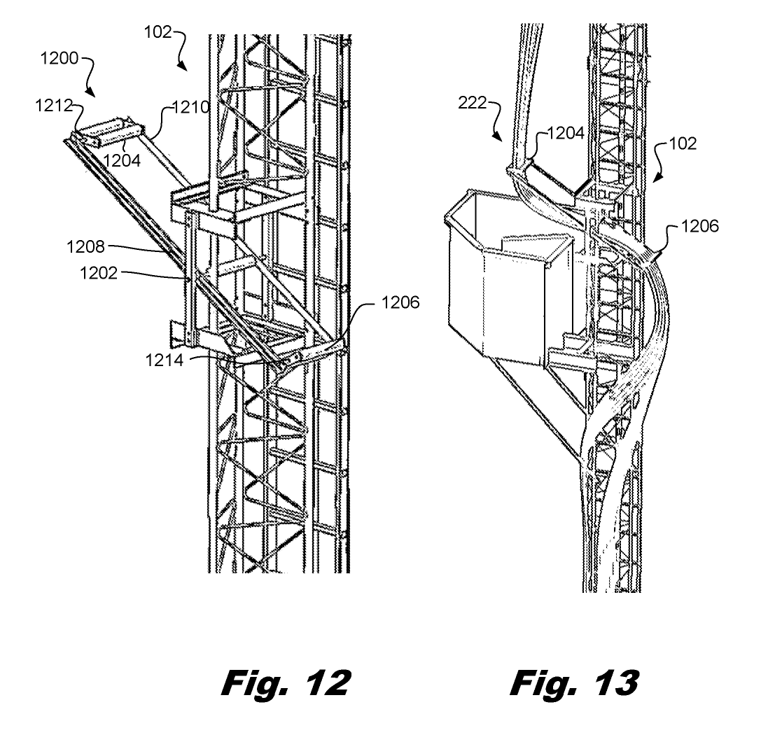

FIGS. 12 and 13 depict an example of a pivot structure 1200 connected to the internal support structure 102. This pivot structure 1200 can be connected to the internal support structure 102 through a pivot joint 1202.

The pivot structure 1200 can also include a first cable loop opening 1204 and a second cable loop opening 1206. The cabling 222 can be secured to the pivot structure 1200 through the first and second cable loop openings 1204, 1206. While this example depicts the pivot structure 1200 with a rectangular frame, any appropriate structure can be used in accordance with the principles disclosed in this disclosure to form the pivot structure 1200.

In the depicted example, the pivot structure 1200 includes a first beam 1208 and a second beam 1210 aligned with the first beam 1208. The first beam 1208 and the second beam 1210 can be connected by a third beam 1212 at a first end of the pivot structure 1200. A fourth beam 1214 can be aligned with the third beam 1212 and connect the first beam 1208 and the second beam 1210 at a second end of the pivot structure 1200.

In one example, the first cable loop opening 1204 is defined in a structure that is pivotally connected to the first beam and the second beam. This structure can move independently of the first beam 1208 and the second beam 1210. The second cable loop opening 1206 can likewise be defined by a structure that moves independently of the first beam 1208 and the second beam 1210. The cabling 222 can be disposed through the first cable loop opening 1204 in the second cable loop opening 1206. The pivot structure 1200 can provide an advantage that prevents undesirable movements of the cabling 222. For example, when a cable is twisted about its axis, the cable can shorten along its length. This yawing movement can cause the cables to shorten along the length of the tower 100. The pivot structure 1200 accommodates the tensions of the cables due to this yawing while providing the appropriate tension on the cables.

In alternative cases, the first beam 1208, second beam 1210, and the third beam 1212 can define at least a portion of the first cable loop opening 1204. In this example, the first beam 1208, second beam 1210, and fourth beam 1214 can define a portion of the second cable loop opening 1206. In some examples, a pivot rod that is part of the pivot joint 1202, can form a portion of the first cable loop opening 1204, the second cable loop opening 1206, or combinations thereof.

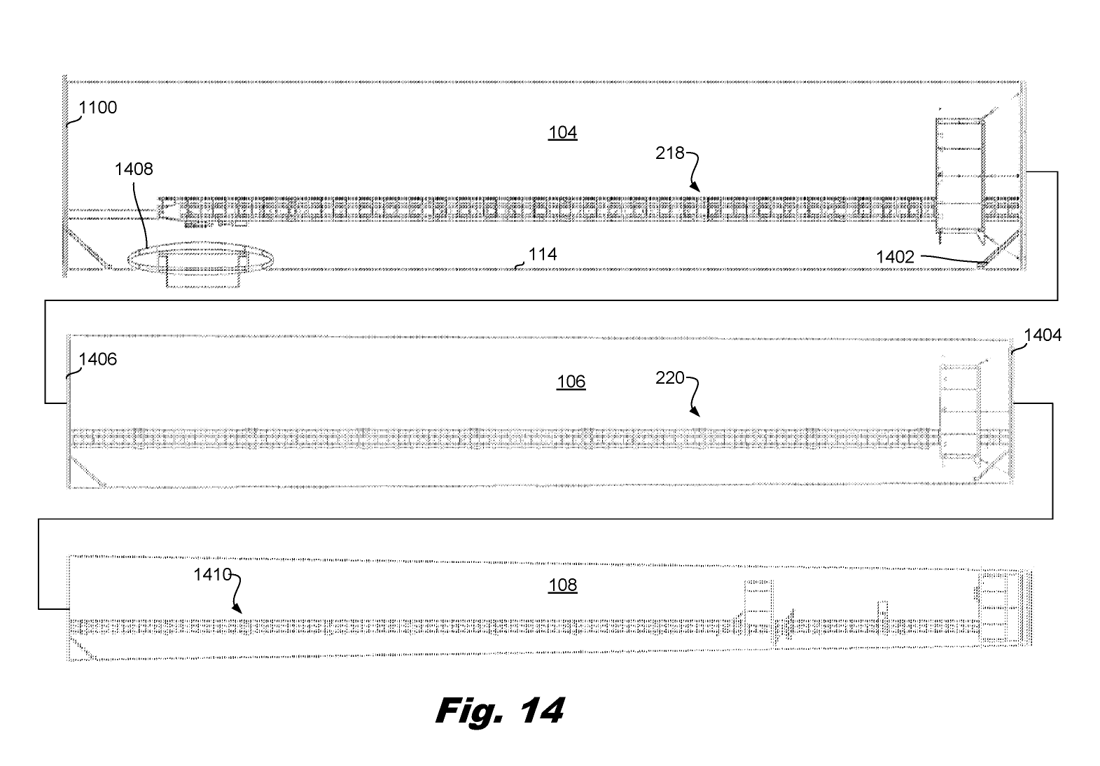

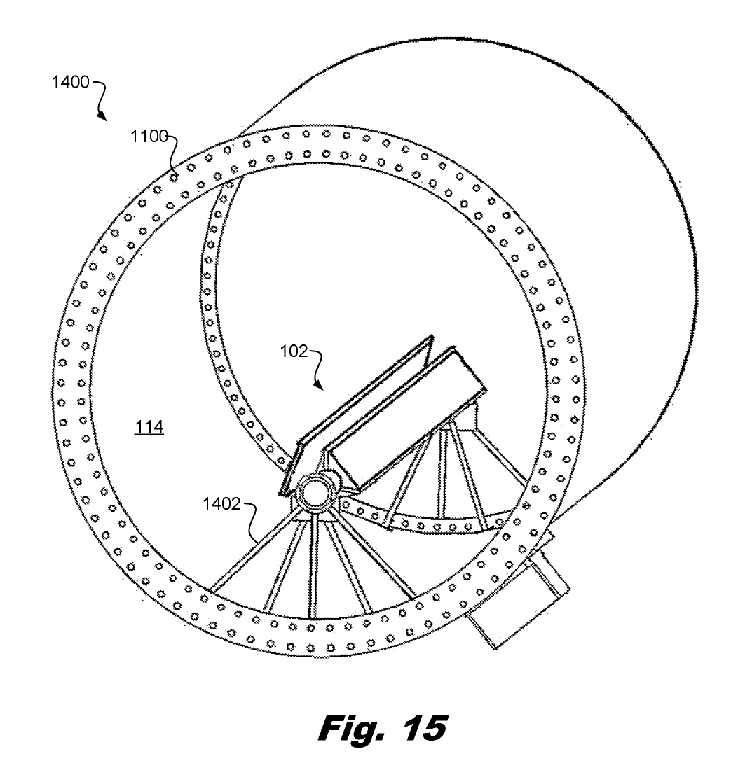

FIGS. 14 and 15 depict an example of annular tower sections in a shipping position 1400 in accordance with aspects of the present disclosure. In the example of FIG. 14, the first annular tower section 104 includes a base portion of the internal support structure 102, a door 1408 to provide access from the outside of the tower 100, and a platform connected to the first connection flange of the annular tower section. The internal support structure 102 is spaced away from the inside surface of the annular tower section with a bracket 1402 connected to the first annular connection flange 1100. When the annular tower section is in the shipping position, such as a position that the tower section can be trucked from one location to another, the bracket 1402 supports the load of the internal support structure 102. However, when the first annular tower section 104 is reoriented into an erected position, the brackets 1402 are no longer load bearing as the weight of the internal support structure 102 will transfer along its length into the tower foundation 120.

The second annular tower section 106 also includes a second annular connection flange 1404 at a first end 110 and a third annular connecting flange 1406 at a second end 112. The second annular tower section 106 also houses a second segment 220 of the internal support structure 102. The second segment 220 is also space away from the inner surface 114 of the tower with brackets 1402 that are connected to second annular connection flange 1404 and the third annular connection flange 1406 respectively. The third tower section 108 also includes a third segment 1410 of the internal support structure 102. This segment 1410 of the internal support structure 102 is also spaced away from the inner surface 114 of the with brackets 1402 connected to respective annular connection flanges.

The description herein is provided to enable a person skilled in the art to make or use the disclosure. Various modifications to the disclosure will be readily apparent to those skilled in the art, and the generic principles defined herein can be applied to other variations without departing from the scope of the disclosure. Thus, the disclosure is not limited to the examples described herein, but is to be accorded the broadest scope consistent with the principles and novel features disclosed herein.

What is claimed is:

1. A tower, comprising:
a plurality of annular tower sections connected to and aligned with one another;
an internal support structure spanning at least a length of the tower; and
a ladder incorporated into the internal support structure.

2. The tower of claim 1, further comprising:
a tower foundation; and
wherein the internal support structure is directly connected to the tower foundation.

3. The tower of claim 1, further comprising:
a first annular tower section of the plurality of annular tower sections;
a second annular tower section aligned with the first annular tower section;
a first annular connection flange connected to the first annular tower section;
a second annular connection flange connected to the second annular tower section; and
a bracket connecting at least one of the first annular tower section or the second annular connection flange to the internal support structure;
wherein the first annular connection flange and the second annular connection flange are bolted together.

4. The tower of claim 3, further comprising:
a tower foundation;
a foundation connection directly connecting the internal support structure to the tower foundation;
wherein the bracket comprises a shipping bracket;
wherein a weight of a segment of the internal support structure is loaded into the bracket when the first annular tower section is oriented in a shipping position;
wherein the weight of the segment of the internal support structure is loaded into the tower foundation at the foundation connection between the internal support structure and the tower foundation when the first annular tower section is oriented in an erected position.

5. The tower of claim 4, further comprising:
a first end of the first annular tower section;
a second end of the first annular tower section opposite the first end of the first annular tower section;
a third annular connection flange located at the second end of the first annular tower section;
an inner surface of the first annular tower section spaced apart between the first annular connection flange and the third annular connection flange;
wherein the inner surface is substantially free of connections to the ladder.

6. The tower of claim 1, wherein the internal support structure comprises a triangular cross section.

7. The tower of claim 1, wherein the internal support structure comprises a truss.

8. The tower of claim 1, wherein the internal support structure defines an internal cavity that is aligned with a length of the internal support structure and at least one cable is disposed within the internal cavity.

9. The tower of claim 1, further comprising:
an opening defined in the internal support structure that connects an outside of the internal support structure to an internal cavity, wherein the ladder is disposed within the opening.

10. The tower of claim 1, further comprising
a platform located within the tower;
wherein the platform is connected to the internal support structure.

11. The tower of claim 10, further comprising:
at least one connection flange located at an end of an annular tower segment; and
at least one suspension cable connected to the at least one connection flange;
wherein the platform is suspended by the at least one suspension cable from the at least one connection flange.

12. The tower of claim 10, wherein the platform further comprises:
a floor, the floor including:
a first floor segment made of a sheet metal material;
a first folded portion of the first floor segment;
a second floor segment made of the sheet metal material; and
a second folded portion of the second floor segment;
wherein the first folded portion and the second folded portion are connected through a non-welded attachment.

13. The tower of claim 12, wherein the sheet metal material comprises a pre-galvanized aluminum material.

14. The tower of claim 1, further comprising:
a first end of an annular tower segment;
an annular connection flange connected to the first end; and
an annular bolt holster connected to the annular connection flange.

15. The tower of claim 1, further comprising:
a pivot joint;
a pivot structure connected to the internal support structure at the pivot joint;
a first cable loop opening incorporated into a first side of the pivot structure; and
a second cable loop opening incorporated into a second side of the pivot structure.

16. The tower of claim 15, wherein the pivot structure pivots in response to a twisting of a cable when a portion of the cable is secure to the first cable loop opening and the second cable loop opening.

17. An annular tower section, comprising:
a segment of an internal support structure spanning at least a length of the annular tower section; and
a ladder incorporated into the segment of the internal support structure;
a first end of the annular tower section;
a second end of the annular tower section opposite of the first end;
a first annular connection flange connected to the first end;
a second annular connection flange connected to the second end;
a bracket connecting the annular tower section to the internal support structure; and
an inner surface of the annular tower section spaced apart between the first annular connection flange and the second annular connection flange;
wherein the inner surface is substantially free of connections to the ladder.

18. The annular tower section of claim 17, wherein the annular tower section is incorporated into a tower;
wherein a weight of the segment of the internal support structure is loaded into a tower foundation at a connection between the internal support structure and the tower foundation; and
wherein the inner surface is substantially free of connections to the internal support structure.

19. The annular tower section of claim 17, further comprising an annular bolt holster connected to at least one of the first annular connection flange or the second annular connection flange.

20. The annular tower section of claim 17, further comprising:
a pivot joint;
a pivot structure connected to the internal support structure at the pivot joint;
a first cable loop opening incorporated into a first side of the pivot structure; and
a second cable loop opening incorporated into a second side of the pivot structure.
